(19) United States
(12) Patent Application Publication
(10) Pub. No.: US 2014/0367401 A1
(43) Pub. Date: Dec. 18, 2014

(54) Product Level Sensor for a Product Dispenser

(71) Applicants: Anders Strålin, Goteborg (SE); Per Möller, Borlange (SE); Johan Lissmats, Borlange (SE)

(72) Inventors: Anders Strålin, Goteborg (SE); Per Möller, Borlange (SE); Johan Lissmats, Borlange (SE)

(73) Assignee: SCA HYGIENE PRODUCTS AB, Göteborg (SE)

(21) Appl. No.: 14/353,143

(22) PCT Filed: Oct. 21, 2011
(86) PCT No.: PCT/EP2011/068425

§ 371 Date: Aug. 1, 2014

(51) Int. Cl. A47K 10/42; G07F 9/02; A47K 10/38

(52) U.S. Cl. CPC A47K 10/424; A47K 10/38; G07F 9/026
USPC 221/6; 242/563; 700/236

(57) ABSTRACT

A dispenser for dispensing paper or non-woven sheet product for wiping, wherein the level of sheet product contained in the dispenser decreases as the sheet product is dispensed, the dispenser comprising an ultrasonic level sensor for determining the level of the sheet product contained in the dispenser, wherein the ultrasonic sensor is arranged to direct the ultrasonic beam toward a surface associated with the sheet product, wherein a distance that the beam travels to the surface changes progressively as the level of the sheet product in the dispenser changes from a full condition to an empty condition.

### FIELD OF THE INVENTION

The present invention is concerned with a dispenser having a product level sensor, a system including such a level sensor and a method of determining a product level contained in a dispenser. The present invention is particularly concerned with sheet product dispensers for dispensing sheet products for wiping. In particular, the sheet product could be a roll of elongate web that is dividable into longitudinal portions so as to form individual sheet products or a stack of sheet products, in particular interfolded sheet products. The sheet product may be toilet tissue, facial tissue, hand wipes, napkins, surface wipes, wet wipes, or the like. The sheet product may be paper based product or other non-woven material.

### BACKGROUND ART

A sensor for determining a product low condition in a sheet product dispenser is known in the art. For example, WO 2005/065509 A1 discloses, with reference to FIGS. 13a and 13b of that document, an infrared sensor 1016 to detect when a paper stack 1018 falls below a low paper point 1020. A narrow beam of infrared light extends from an emitter 1021 and is picked up by an adjacent detector 1023. When the top of the paper stack 1018 lies above the infrared sensor 1016, the detector 1023 does not pick up infrared light. When the top of the paper stack lies below the infrared sensor 1016, light from the emitter 1021 is visible to the detector 1023, thereby determining a product low condition.

Such an infrared sensor is power burdensome, particularly if the dispenser is battery powered, as is often the case. Further, the infrared sensor is a binary device in that the stack is either below the line of infrared light or above it, to respectively indicate a low product condition or a sufficient product condition. It is one of the objects of the present invention to overcome these problems.

### SUMMARY OF THE INVENTION

In a first aspect of the invention, there is provided a dispenser for dispensing sheet product for wiping, wherein the level of sheet product contained in the dispenser decreases as the sheet product is dispensed, the dispenser comprising an ultrasonic level sensor for determining a level of the sheet product contained in the dispenser. In one aspect, the ultrasonic level sensor is configured to emit an ultrasonic beam and sense an echo to allow a determination to be made on the level of the sheet product contained in the dispenser. In one aspect, the level sensor is configured to emit an ultrasonic beam at a surface of the sheet product or a surface indicative of the level of the sheet product and sense an echo received from the surface to allow a determination to be made on the level of the sheet product contained in the dispenser.

As the sheet product is dispensed from the dispenser, the distance that the ultrasonic beam traverses for the ultrasonic sensor to detect the echo progressively increases. In one aspect, it is this change in distance as the sheet product depletes that allows the ultrasonic sensor to produce a quantitative representation of the extent of sheet product depletion from a full condition to an empty condition.

According to the first aspect of the invention, the level sensor is provided in the form of an ultrasonic sensor. An ultrasonic sensor allows a distance to the sheet product to be determined to sufficiently high precision that the level of the sheet product, even in the limited confines of a dispenser. Further, an ultrasonic sensor allows quantitative data representative of the level of sheet product to be determined, which is an improvement over mere binary systems indicating either “full enough” or “low” with respect to the sheet product. Further, an ultrasonic sensor is a low power device compared to an LED sensor for sensing an interruption in an LED path as used in the prior art.

In aspects of the present invention, the dispenser comprises a sheet product reservoir and a dispensing opening through which the sheet product is dispensable to reduce the sheet product level in the reservoir. The dispenser preferably comprises a housing defining the product reservoir for protecting the sheet product from exposure to dirt, dust, water, etc. The housing is preferably openable to refill the product reservoir with sheet product.

In a second aspect of the invention, there is provided a method of determining a level of sheet product for wiping in a dispenser, wherein the level of sheet product in the dispenser decreases as the sheet products are dispensed from the dispenser, comprising:

determining from an ultrasonic echo a level of the sheet product contained in the dispenser.

In one aspect, the method comprises emitting an ultrasonic beam and sensing the echo, and determining from the sensed echo the level of product contained in the dispenser.

In one aspect, the method comprises emitting an ultrasonic beam at a surface whose level changes in indication of the level of sheet product contained in the dispenser,

sensing an echo of the ultrasonic beam reflected from the surface, to thereby garner an indication of the product level contained in the dispenser.

In a third aspect of the invention, there is provided a system for determining a level of sheet product contained in the dispenser, wherein the level of sheet product in the dispenser decreases as the sheet products are dispensed from the dispenser, the system comprising:

the dispenser;

an ultrasonic level sensor; and

a processor configured to

determine a level of the sheet product based on an ultrasonic echo sensed by the ultrasonic level sensor. The processor may be part of the dispenser, or an external component to the level sensor of the dispenser by a communications channel, such as a wireless communications channel. In this way, the level determination could be done at the dispenser or at a control device that is also in communication with other devices, such as other dispensers.

In one aspect of the system, the ultrasonic level sensor is arranged to emit an ultrasonic beam to a surface whose level changes in indication of the level of sheet product, and configured to sense an echo from the surface.

In one aspect, the ultrasonic level sensor is configured to emit an ultrasonic beam and sense an echo of the ultrasonic beam.

In one aspect of the dispenser or the system, the ultrasonic beam is directed toward a surface associated with the sheet product, wherein a distance that the beam travels to the surface changes progressively (more specifically, increases) as the level of the sheet product in the dispenser changes. In one aspect, a distance to the surface that the beam traverses changes progressively (or more specifically increases) as the level of sheet product in the dispenser changes from a full condition to an empty condition.

The surface is preferably a surface of the sheet product, but may be a surface configured for enhancing ultrasonic reflection as compared to a surface of the sheet product. For example, the surface could be a layer adhered or coated on the sheet product or a member that rests on the sheet product and moves between different positions as the level of the sheet product upon which the member rests, changes. The member could, for example, be a member pivotally or otherwise movable with respect to a housing of the dispenser.

In one aspect of the dispenser, the level sensor outputs a signal indicative of a distance traversed by the echoed ultrasonic beam, which signal is indicative of a distance from the ultrasonic level sensor to the surface, thereby allowing the level of the sheet product in the dispenser to be determined. In one envisaged implementation, the level sensor includes a piezoelectric element that outputs a signal characteristic of the return echo from the sheet product. The time that the signal is received is indicative, when taken in combination with the time that the ultrasonic sensor is driven, of the distance that the beam has traversed, which indicates product level.

Put another way, an echo receipt signal is outputted, which is useable in combination with a beam transmission signal, for determining a distance indication to the sheet product, which is representative of the sheet product level in the dispenser.

This distance data also allows quantitative data on the level of the sheet product to be able to more accurately determined when the sheet product is likely to need replenishing.

In an aspect of the system, the processor is configured to determine data indicative of a distance traversed by the echoed ultrasonic beam, which data is indicative of a distance from the sheet product, thereby indicating the level of the sheet product contained in the dispenser.

Put another way, the processor is configured to receive an echo receipt signal from the ultrasonic level sensor and a beam transmission signal and to determine a distance indication to the sheet product from the signals, which is representative of the level of sheet product in the dispenser. The ultrasonic beam may reflect from the surface once or multiple times and the distance indicating data may be taken from a single traverse from an emitter to the surface and back again or multiple traverses. In the former alternative, the ultrasonic signal will be less noisy, whereas in the latter alternative, the total distance traversed is greater, potentially providing a more accurate result.

In an aspect of the dispenser, the ultrasonic level sensor outputs a first signal concerning the ultrasonic beam that is emitted and a second signal concerning the echo of the ultrasonic beam, which data is comparable to determine a distance to the sheet product, wherein the distance changes as the level of the sheet product changes. For example, the output data could be data on the time the beam is emitted and the time the echo is sensed, or phase data on the beam emitted and the echo sensed.

In an aspect of the system, the processor is configured to compare a signal from the ultrasonic level sensor concerning the ultrasonic beam echo sensed with a signal concerning the ultrasonic beam emitted to determine an indicator of a distance to the sheet product, wherein the distance changes as the sheet product level changes to determine the level of the sheet product in the dispenser. In particular, the processor of the system is configured to use time of flight data, phase shift data or data for other range finding algorithms of the ultrasonic beam emitted and the echo sensed to determine an indicator on the distance to the sheet product, which is representative of the sheet product level in the dispenser.

In aspects of the system, the processor is configured to determine at least three (4, 5, 6, 7, 8, 9, 10 or more) discrete levels of sheet product contained in the dispenser from the ultrasonic echo or to determine the sheet product level in a continuous manner as the sheet product depletes from the dispenser. The method may also perform such a discrete or continuous sheet product level determination from the ultrasonic echo.

In aspects of the system, method and dispenser, the sensor comprises a driver for issuing a drive signal and an ultrasonic element that issues the ultrasonic beam in response to the drive signal. The drive signal and a sensed beam echo signal allow distance data to be determined (particularly by a processor, which may be part of the dispenser and is part of the system) on the distance traversed by the ultrasonic beam, thereby allowing the product level to be determined.

In an aspect of the method, a characteristic of the ultrasonic beam emitted is compared to a corresponding characteristic of the echo to determine an indication of the distance to the sheet product, which is representative of the level of sheet product contained in the dispenser. The characteristic may be time or phase. The method may use any other range finding algorithm to determine an indication of the distance to the sheet product.

In aspects of the method and the system, distance data is determined (e.g. by the processor) on the distance to the sheet product or the distance traversed by the ultrasonic beam.

In aspects, distance data is determined from a difference between the time when an echo beam is detected and a time when the ultrasonic beam was emitted (e.g. based on the time that a drive signal was applied). This gives a time of flight of the ultrasonic beam. From data on the speed of sound and from the time of flight, the distance traversed by the beam in travelling to and from the sheet product is determinable.

The distance data will reveal a relatively short travel path when the dispenser is full and thus located closer to the ultrasonic sensor. As the sheet product enters a low state, the distance sensor is able to calculate a spectrum of distances from the full condition to the empty condition, thereby enabling a quantitative result to be determined indicating the stack level in the dispenser. This compares favourably with a qualitative or binary approach.

In an aspect of the method, the ultrasonic beam travels toward and reflects off a surface associated with the sheet product to produce the echo, wherein a distance travelled by the ultrasonic beam to the surface progressively changes (e.g. increases) as the sheet product level changes (e.g. decreases), particularly from a sheet product full condition to an empty condition.

In an aspect of the dispenser and the system, the ultrasonic level sensor is arranged to emit the ultrasonic beam so that a central axis of the beam extends substantially perpendicularly with respect to the surface. Perpendicular positioning of the surface and the beam provides for the reflected signal to be more clearly defined, enabling the echo signal to be more easily detected. According to an aspect of the method, the ultrasonic beam is emitted so that a central axis of the beam extends perpendicularly with respect to the surface.

In an aspect of the dispenser, the system and the method, the ultrasonic beam has a frequency of 30 kHz or greater. In an embodiment, the frequency is 50 kHz or greater, 100 kHz or greater, 200 kHz or greater 300 kHz or greater or 400 kHz or greater. Ultrasonic level sensors have been tested at a number of frequencies including a lower frequency 40 kHz and a higher frequency 200 kHz.

The higher frequency has a narrower beam, which tends to avoid the beam and the echo being disturbed by interference from other components of the dispenser, whereas the lower frequency devices tend to be less expensive to produce.

In an aspect of the dispenser and the system, the ultrasonic level sensor comprises a horn for narrowing the ultrasonic beam. Again, this feature serves to avoid interference off housing components of the dispenser, which may obscure the echo signal. In an embodiment of the method, a horn is used to narrow the ultrasonic beam as it is emitted.

In an aspect of the dispenser and the system, the ultrasonic level sensor includes an ultrasonic transceiver that is able to perform the tasks of both transmitting and receiving. In such an implementation, a sufficient time has to elapse between a drive signal being applied to the transceiver for emitting the ultrasonic beam and a sensing operation of the echo signal so that the vibrations from the drive signal have sufficiently dissipated for the echo signal to be distinguishable. This requirement to prevent overlap in the drive and echo signals can limit the minimum distance that can be measured, which is an important consideration in view of the limited space available in the dispenser. To combat this issue, one possibility would be to include a vibration dampener to stabilise the vibrations of the transmitter after the drive signal has been applied. This enables a transceiver to be used while still being able to measure sufficiently short distance for use in the confined space of a dispenser.

An ultrasonic transmitter can also be provided in the system or dispenser for emitting the ultrasonic beam and an ultrasonic receiver can be provided for sensing the echo as separate components. When separate components are used, there is no need to provide a vibration dampening means. In a separate component implementation, a time for allowing the ultrasonic transmitter to settle does not have to elapse. Put another way, a vibrating component (e.g. a piezoelectric element) of the ultrasonic transmitter is vibrationally independent of a vibrating component of the ultrasonic receiver. In such an embodiment, the ultrasonic transmitter and the ultrasonic receiver have independent connections for respectively carrying a drive signal and a sensed signal.

In an aspect of the method, the method comprises emitting the ultrasonic beam using an ultrasonic transmitter and receiving the echo using a functionally independent ultrasonic receiver. In an alternative form, the method comprises emitting the ultrasonic beam and receiving and sensing the echo using an ultrasonic transceiver.

In an aspect of the system and the dispenser, the transmitter and the receiver are positioned adjacent to one another in the context of the whole dimensions of the dispenser. In particular, following the shortest lines that connect the transmitter to the surface and the receiver to the surface, which intersect at the surface, the maximum angle between these lines is 40°, 30°, 20° or even 10°. Further, the transmitter and receiver are preferably arranged so that a central axis of the emitted beam and the echo respectively follow these shortest lines.

In an aspect of the dispenser, the system and the method, the dispenser includes a product housing defining an interior area shaped to receive a stack of sheet products. The stack may be interfolded sheet products. The interior area may defined by the housing may be substantially oblong shaped to receive a substantially oblong shaped stack.

In such an aspect, the ultrasonic level sensor is positioned to direct an ultrasonic beam toward a surface of the stack that moves away from the sensor as the sheet products in the stack are dispensed and the stack consequently depletes and to receive an echo from the surface. In an aspect, the ultrasonic level sensor is located in a top of the housing, wherein the sensor directs the ultrasonic beam in the stacking or dispensing direction (+z direction taking the dispensing or stacking direction as a z axis) and receives an echo directed oppositely in the stacking or dispensing direction (−z direction). The ultrasonic level sensor is positioned to direct the beam at a top or bottom surface of the stack in the stacking direction wherein a distance to the surface changes progressively as the sheet product is dispensed.

In another aspect of the dispenser, the system or the method, the dispenser comprises a product housing for receiving a roll of sheet product. The roll may define a continuous elongate web, which may be divided by lines of weakness extending laterally across the web to provide individual sheet products. In aspects, the dispenser includes an axle about which a core portion of the roll of sheet product rotates.

The ultrasonic level sensor is arranged to direct an ultrasonic beam at a circumferential surface of the roll. The ultrasonic level sensor may be arranged to direct the beam substantially radially and to receive a substantially radially directed echo.

In aspects, the product depletes so that the product level moves in a first direction and the ultrasonic sensor is configured to direct the ultrasonic beam in the first direction.

The ultrasonic sensor can be battery operated since the ultrasonic transmitter and receiver or transceiver is a relatively low power consumption device.

The dispenser may include a low product condition indicator light in communication with the ultrasonic sensor configured to light up once the determined sheet product level in the product housing goes below a product low threshold. The ultrasonic sensor may also be in communication with a wire or wired telecommunication means. The telecommunication means may be operable to send a signal to a receiving unit to report to a maintenance attendant that stack replenishing is required.

The ultrasonic sensor may not itself carry out distance calculations to determine the sheet product level in the dispenser. Instead, the ultrasonic sensor could be provided with a transmission device that reports outputs of the ultrasonic sensor in a wired or wireless manner to an external computing unit to do necessary calculations from the transmitted data concerning the emitted ultrasonic beam and the reflected ultrasonic beam for working out the sheet product level in the dispenser. This external computing unit could also be used to issue alerts to maintenance personnel for replenishing the sheet product in the dispenser.

Preferably, the stack level determination is carried out by a processor that is part of the dispenser (as described previously). The ultrasonic sensor may nonetheless be in communication with a transmission device that is also part of the dispenser so that product level data can be transmitted externally for possible use in various systems, as will be detailed in the following.

As stated above, the ultrasonic sensor could be in communication with a product low indicator such as an LED for indicating a product low condition. Alternatively or additionally, the dispenser includes a transmitting device so that a product low condition can be transmitted to an external computing unit, such as a mobile telecommunications device of a maintenance attendant or a computing unit of a maintenance office that includes an interface for communicating the product low alert to a maintenance attendant. A maintenance alert can then be determined by a local processing unit or an external processing unit.

In an aspect of the system, the processor is configured to determine a quantitative result indicating the level of sheet product in the dispenser. Similarly, in an aspect of the method, the method includes the step of determining a quantitative result indicating the level of sheet product in the dispenser. The quantitative result may be an indicator of distance to the sheet product (e.g. a distance from an ultrasonic emitter to an ultrasonic receiver via the sheet product, or a distance to and from the sheet product from an ultrasonic transceiver) or an indicator of percentage of product dispensed. A quantitative result provides greater product level information than a binary device for determining a product low condition. The present invention allows a quantitative value to be given on the level of the sheet product. This quantitative value is particularly valuable for statistical and ordering purposes, as will be discussed in further detail below.

In an aspect of the system, the system is configured to determine when the product is low based on the sheet product level determination and alert a maintenance attendant when the product is determined to be low so that the maintenance attendant is informed of a sheet product replenishment requirement for the dispenser. This is a labor saving feature, since the maintenance attendant is informed when the dispenser needs replenishing as compared to the maintenance attendant doing a periodic check which may or may not prove positive in terms of product replenishment.

The product low condition may be determined by a processor at the dispenser, or a remote processor. For example, the dispenser may be in wired or wireless communication with a local processing unit or an outside processing unit, which will be described further below, that carries out the product low determination.

In an aspect of the method, the method comprises determining a product low condition from the determination of the product level in the dispenser and alerting a maintenance attendant when a product low condition is determined.

The alert can be sent to a mobile telecommunications device (such as a PDA, a mobile phone (cellphone), etc.) so that a maintenance attendant can be informed of the replenishment requirement on the go. The alert so sent may be a text message, an email, an automated voice call, or an alert on a webpage that the mobile device is connected to, etc. The alert may also be displayed on a graphical user interface of a computer used by a maintenance attendant. Thus, the maintenance attendant could monitor the graphical user interface from a maintenance office to determine when a replenishment operation is required by the dispenser.

There might also be provided at least one further dispenser having a product level sensor. The dispenser and the level sensor could be as described in the foregoing so that the level sensor works using the ultrasonic means previously described. Alternatively, the at least one further dispenser includes a conventional level sensor such as an infrared sensor or a capacitive proximity sensor. The at least one further dispenser may include a soap dispenser, roll sheet product dispenser, and/or a stack sheet product dispenser.

In an aspect, the dispenser and, if provided, the at least one further dispenser are configured to report in a wired or wireless manner a determined product level to a local processing unit or to an external processing unit. The local processing unit or the external processing unit can be configured to determine a product low condition and report an alert to a maintenance attendant. The alert reporting mechanism may be as described above. Each dispenser may report with the product level information a unique identifier for the dispenser so that the level information can be distinguished for each dispenser.

In an aspect, the system includes a stock monitoring and ordering system configured to monitor product level sensors of a plurality of dispensers, including the aforedescribed ultrasonic level dispenser, and to order or deliver new stock when the stock is determined to be low. This is particularly advantageous in the context of a system of ultrasonic level sensing dispensers because such dispensers allow an accurate quantitative determination of the product level, which will allow the stock system to closely follow product conditions in the dispenser to properly time order or delivering of new product.

Further, the stock monitoring and ordering system may include a database for storing product level information for each of the dispensers. The stock monitoring and ordering system can be configured to produce sales or usage related statistics based on the information contained in the database. The stock monitoring and ordering system may be associated with a customer, in which case the system is configured to send an order for product delivery. Alternatively, the stock monitoring and ordering system may be integrated with a supplier or distributors logistics system in which case the supply of replacement product and billing can be automated.

In general, the local processing unit mentioned above can be configured to communicate with a plurality of product dispensers each having a level sensor, including the ultrasonic level sensing dispenser of the present invention. The local processing unit communicates with a plurality of dispensers within a communication catchment area. This catchment area may, for example, be a particular washroom, or a plurality of washrooms, or it may be a particular building. The local processing unit can also construct a webpage available over an inter or intranet that allows a maintenance attendant or other interested party (such as a supplier) to view the level conditions in each dispenser. The information is particularly useful in the context of dispensers using the present ultrasonic level sensor since an accurate quantitative analysis of the product levels can be gained.

There may be a plurality of local processing units as described above and each of them can be in communication with an external processing unit. The external processing unit may include or be associated with the above mentioned stock monitoring and ordering system. In this way, the information from a plurality of catchment areas is processed by the stock monitoring and ordering system. The product level information received from each local processing unit includes a unique identifier associated with each local processing unit so that the stock information and usage statistics can be associated with a particular catchment area.

It may be the external processing unit that is configured to issue a low product alert to a maintenance attendant in one of the manners described above. The external processing unit is, in an embodiment, configured to issue the alert identifying the local processing unit or the dispenser with which the product low condition is associated so that the maintenance person can know where to go.

Door or entrance sensors in a washroom may be provided that allow washroom usage information to be gathered. Such usage sensors may also communicate with the local processing unit and be passed on to the system for monitoring and ordering stock so that it can be stored in the database. Again, this will provide interesting sales and stock usage statistics for a supplier (such as amount of sheet product per visit to the bathroom) in a discrete way.

### BRIEF DESCRIPTION OF THE DRAWINGS

FIG. 1 discloses a dispenser including a product housing defining an interior area for holding a stack of sheet products. The dispenser is shown in a condition in which the interior area is about half full with sheet products. The dispenser includes an ultrasonic sensor arranged to aim a beam of ultrasonic energy so as to reflect off the stack of sheet product for the echo to be detected by the ultrasonic sensor. As the sheet product is disposed from the dispenser, the distance that the ultrasonic beam traverses for the ultrasonic sensor to detect the echo progressively increases. It is this change in distance as the sheet product depletes that allows the ultrasonic sensor to produce a quantitative representation of the extent of sheet product depletion from a full condition to an empty condition.

FIG. 2 discloses an alternative embodiment to that shown in FIG. 1, in which an ultrasonic sensor is applied to a roll of an elongate sheet. In the dispenser of FIG. 1, the ultrasonic beam is directed toward a planar major surface of the sheet product in the stack. In the dispenser of FIG. 2, the ultrasonic beam is directed at a circumferential surface defined by an outer circumference of the roll. As the sheet product is dispensed, the distance to the circumference gets larger as the radius of the roll decreases, and so the distance that the ultrasonic beam traverses in being reflected from the surface so that the echo is detected increases. Again, it is this change in distance that allows a quantitative representation of the extent of depletion of the roll product to be determined.

FIG. 3 discloses a washroom having a paper towel dispenser and a soap dispenser. The washroom also includes a local processing unit that is in communication with a level sensor in the paper towel dispenser and perhaps also in the soap dispenser so that the level sensors can transfer product level information to the local processing unit.

FIG. 4 shows a block diagram of a system to which ultrasonic level dispensing apparatus as disclosed in the present invention are applicable. In particular, the dispensers in one or more washrooms are in communication with a local processing unit for communicating product levels in the dispensers. There are a plurality of local processing units that are in communication with an external processing unit that is able to gather the level information. The external processing unit is able to issue alerts so that a maintenance attendant can attend to any dispensers that have a low product condition. The external processing unit is also shown to be in communication with a stock monitoring and ordering system so that the inventory for a particular customer can automatically be monitored and updated and new orders be placed, processed, delivered, and billed using the product low information issued by the dispensers.

### DETAILED DESCRIPTION OF EMBODIMENTS

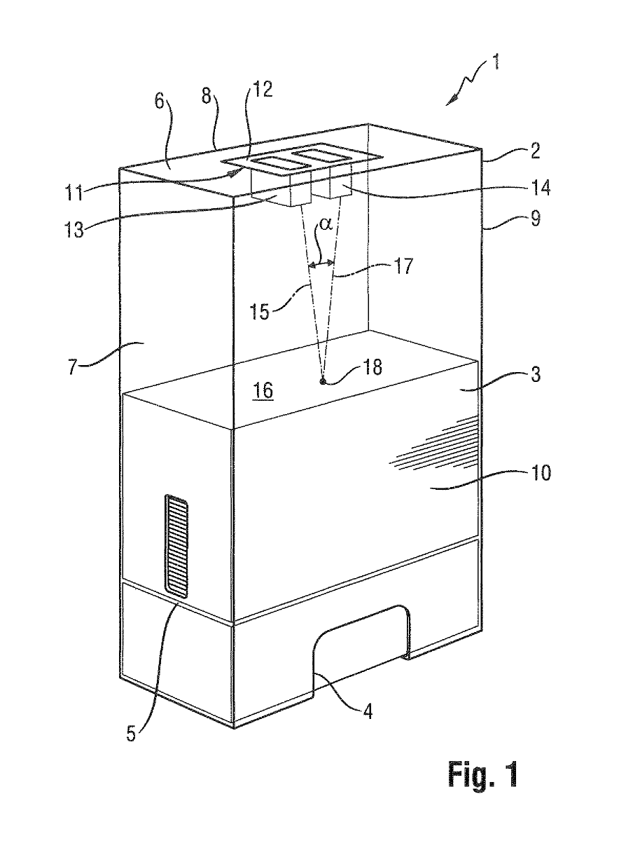

FIG. 1 shows a dispenser according to an embodiment of the present invention. The dispenser 1 is of a known kind and defines a product housing 2 shaped to define an interior area for receiving and supporting a stack 3 of sheet products 3. In the embodiment shown, the sheet product may be interfolded or folded paper towels. The principles of the present invention are, however, applicable to any other types of sheet product for wiping, such as facial tissues, napkins, surface wipes, web wipes, etc.

The interior area of the product housing 2 defines a product reservoir, which is about half full in the shown embodiment. The dispenser 1 includes a dispensing opening 4 through which an individual sheet product from the stack 3 is dispensable for use. When the stack 3 is made up of interfolded individual sheet products in this embodiment, it means that the dispensing of one product pulls into the dispensing opening 4 a preceding product in the stack. In the embodiment, the sheet products in the sheet 3 are dispensed downwardly, with respect to gravity. There are, however, known upward dispensing dispensers, to which the principles of the present invention are applicable.

The product housing 2 is defined by bottom and top walls 5, 6 and four sidewalls 7, 8, 9, 10 extending between the top and bottom walls 5, 6 to define a generally oblong interior area for accommodation of a generally oblong shaped stack 3. The oblong shape of the product housing 2 is elongated in a top to bottom direction (or the dispensing direction), which can also be considered a Z-direction.

The dispenser comprises an ultrasonic sensor 11 that includes a mounting plate 12, an ultrasonic transmitter 13 and an ultrasonic receiver 14. The mounting plate 12 is mounted to an inside surface of the top wall 6 in a generally central location in the X-Y plane so that a beam of ultrasonic energy 15 is directed at a top surface of the stack 16, which is formed by a trailing panel of the last individual sheet product in the sheet 3. The ultrasonic transmitter 13 is aimed so that it impedes against a generally central location of an X-Y plane perpendicular to a stacking direction of the dispenser 1 and so that an echo beam 17 is received at the ultrasonic receiver 14. In the embodiment, the point at which the transmitted ultrasonic beam 16 and the reflected ultrasonic beam 17 reflects from the top surface 16 of the stack 3 is indicated by reference numeral 18.

Use of the ultrasonic sensor 11 in one way of determining a level of the stack 3 in the product reservoir 2 will now be described. A drive signal is applied to a piezoelectric element of the ultrasonic transmitter 13 so that an ultrasonic beam is transmitted toward the top surface 16 of the stack 3 and is reflected from the top surface 16 so that the echo 17 is received at the ultrasonic receiver 14. In an embodiment, the ultrasonic sensor 11 includes a processor that is configured to determine a distance traversed by the beams 15, 17 to produce an indication of the distance to the top surface 16 of the stack 3. This distance can be determined from a difference between the time when the echo beam 17 is first detected and a time when the ultrasonic beam was sent out (based on the time that the drive signal was applied). This gives a time of flight of the ultrasonic beam. From knowledge of the speed of sound in air at room temperature (343 m/s) and from the time of flight, the processor is able to determine a distance traversed by the beam in travelling to and from the top surface 16 of the stack 3.

The above distance data will reveal a relatively short travel path when the stack 3 is full and thus is located closer to the ultrasonic transmitter 13 and receiver 14. As the stack 3 enters a low product state, the distance determined will be increased. Thus, the ultrasonic sensor 12 is able to calculate a spectrum of distances from the full condition to the empty condition for the stack 3, thereby enabling a quantitative result to be produced by the ultrasonic sensor 11 indicating the stack level in the dispenser 1. This compares favourably with qualitative approaches taken in the prior art described above.

In the shown embodiment, the ultrasonic sensor 11 is generally located centrally between the sidewalls 7, 8, 9, 10 of the product housing 2 so as to avoid interference of the ultrasound with the sidewalls, which can make discerning which signal is produced by an echo from the stack 3 more difficult. As described above, the ultrasonic sensor 11 preferably operates in the frequency range of 40 kHz to 400 kHz for cost reasons, although a narrower beam (and thus less interference) is possible toward the upper limit of this frequency range (i.e. from 200 kHz or 250 kHz to 400 kHz). A narrow ultrasonic beam is generally desirable for interference reasons, but it can be made too narrow, which could mean that the receiver 14 is not able to receive the echo 17 for all stack heights from full to empty, particularly with very tall dispensers.

The ultrasonic sensor 11 can be battery operated since the ultrasonic transmitter 13 and receiver 14 is a relatively low power consumption device.

The dispenser 1 may include a low product condition indicator light (not shown) in communication with the ultrasonic sensor 11 which lights up once the determined stack level in the product housing 2 goes below a product low threshold. The ultrasonic sensor 11 may also be in communication with a wireless or wired telecommunication means that sends a signal to a receiving unit to report to a maintenance attendant that stack replenishing is required.

In an embodiment, the ultrasonic sensor 11 does not itself carry out the distance calculations to determine the stack level in the product housing 2. Instead, the ultrasonic sensor 11 could be provided with a transmission device that reports the data in a wired or wireless manner to an external computing unit (such as the local processing unit or the external processing unit described below) to do the necessary calculations from the transmitted data concerning the emitted ultrasonic beam 15 and the reflected ultrasonic beam 17 for working out the stack level in the dispenser 1. This external computing unit could also be used to issue alerts to maintenance personnel for replenishing the sheet product in the product housing 2.

It is the preferred embodiment, however, that the stack level determination is carried out by a processor that is part of the dispenser 1, as described previously. In this preferred embodiment, the ultrasonic sensor 11 is, nonetheless, in communication with a transmission device that is also part of the dispenser 1 so that product level data can be transmitted externally for possible use in various systems, as will be detailed in the following.

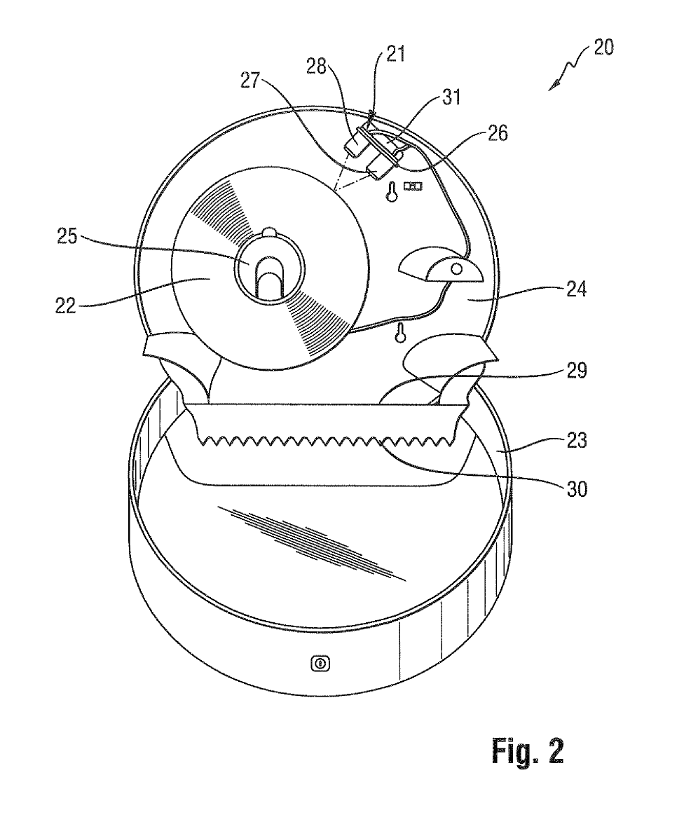

FIG. 2 shows another embodiment of a dispenser including an ultrasonic level sensor. This embodiment is given to show that the ultrasonic level sensor of the present invention is applicable to all variety of known sheet product dispensers. Accordingly, the description given above with respect to the ultrasonic level sensor 11 is applicable as a description for the ultrasonic level sensor 21 of the embodiment of FIG. 2.

In the embodiment of FIG. 2, there is shown a dispenser 20 for dispensing sheet products in the form of a roll 22 made up of an elongate web. The elongate web includes laterally extending lines of weakness so as to define individual sheet products that are longitudinally separated from one another by the lateral lines of weakness. In an alternative, the elongate web forming the roll 22 is continuous, i.e. does not include preformed lines of weakness and the dispenser includes a serrated surface 30 or the like for dividing the continuous web.

The dispenser 20 is shown in an open configuration, wherein a cover 23 is disposed open with respect to a base plate 24, which open condition is used for refilling the dispenser 20. The cover member 23 is closed with respect to the base plate 24 for normal use.

The dispenser includes a spindle 25 to which the roll product 22 is rotatably mounted. That is, the spindle 25 is provided to receive a core portion at the centre of the sheet product roll 22. The base plate 24 includes an upstanding member that extends axially with respect to the spindle axis or an axis passing through a core portion of the sheet product roll 22. The ultrasonic sensor 21 includes a mounting plate 26 as described above with reference to FIG. 1. The mounting plate 26 is mounted to the upstanding member 31 so that the ultrasonic transmitter 27 and the ultrasonic receiver 28 are positioned to direct and receive ultrasonic beams transmitted to and reflected from a circumferential surface of the product roll 22. That is, the ultrasonic transmitter 27 is oriented so as to transmit the ultrasonic beam at a major surface of the sheet product forming an outer circumferential surface of the product roll. The circumferential surface has an axial extent defined by a lateral dimension of the sheet product. The transmitted ultrasonic beam from the ultrasonic transmitter 27 is directed at a central portion of the circumferential surface of the sheet product roll 22 with respect to a lateral width of the sheet product.

The ultrasonic sensor 21 is located at a top portion of the dispenser 20 with respect to a dispensing opening 29 that is located at a bottom portion of the dispenser 20. This feature serves to ensure that interference associated with a leading portion of the sheet product extending through the dispensing opening 29 does not interfere with the ultrasonic energy beams.

In use, a user dispenses sheet product by pulling on a leading portion of the sheet product extending through the dispensing opening 29. A serrated edge 30 is provided at a front wall member partially defining the dispensing opening 29. The user stresses the dispensed sheet product against the serrated edge 30 so that the sheet product tears at a corresponding line of weakness. As the sheet product is dispensed, a radial extent of the sheet product roll 22 will progressively decrease. That is, a distance that an ultrasonic beam travels from the ultrasonic transmitter 27 to the ultrasonic receiver 28 steadily increases from a condition when the roll 22 is unused to a product low condition nearing when the roll 22 is substantially used up. This change in radial distance in the sheet product 22 is determined by a process of the ultrasonic sensor, from determining a distance traversed from the ultrasonic transmitter 27 to a reflection from the circumferential surface of the roll 22 back to the ultrasonic receiver 28, so as to obtain a quantitative indication of the level of the sheet product contained in the dispenser 20.

As before, the ultrasonic sensor 21 could be configured to determine a product low condition by comparing the level of the products in the dispenser as determined by the ultrasonic sensor 21 to a threshold. The ultrasonic sensor could be in communication with a product low indicator such as an LED for indicating the product low condition. Alternatively or additionally, the product low condition could be transmitted to an external computing unit, such as a mobile telecommunications device of a maintenance attendant or a computing unit of a maintenance office that includes an interface for communicating the product low alert to a maintenance attendant. Preferably, a transmission device of the dispenser 20 is configured to report product level data as determined by the ultrasonic sensor 21 to a local processing unit or an external processing unit as described below. The maintenance alert could then be determined by the local processing unit or the external processing unit.

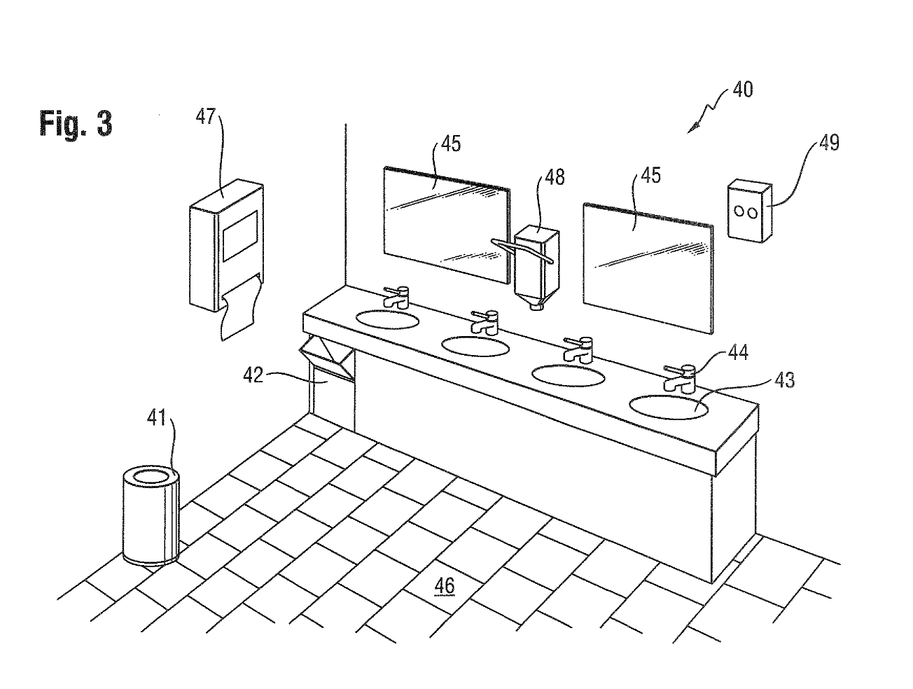

In FIG. 3, there is disclosed a washroom 40 including the usual utensils such as bins 41, 42, sinks 43, taps 44 for the sinks, mirrors 45 and a washroom floor 46. Also arranged in the washroom 40 is a paper towel dispenser 47 in which the paper towels are arranged in stack form. The discussion given above with respect to the paper towel dispenser 1 is thus applicable to the paper towel dispenser 47. There is also shown a soap dispenser 48 for dispensing soap at the sinks 43, 44 so that a user can wash their hands. The user will then move to the paper towel dispenser 47 and dispense one or more paper towels to dry the hands with.

In addition or alternatively to the paper towel dispenser 47, there may be provided a toilet tissue dispenser as described above with respect to the dispenser 20 of FIG. 2. Further, the paper towel dispenser 47 may not necessarily be of stack form but may have towels for wiping the hands in roll form. Each of the paper dispensers preferably include an ultrasonic level sensor configured as described with respect to FIGS. 1 and 2, as relevant. The soap dispenser 48 may also include a soap level dispenser A conventional level sensor may be used for determining the soap level in the dispenser 48. Each of the dispensers 47, 48 comprises a transmission means for communicating the level data, and perhaps other dispenser information to a local processing unit 49.

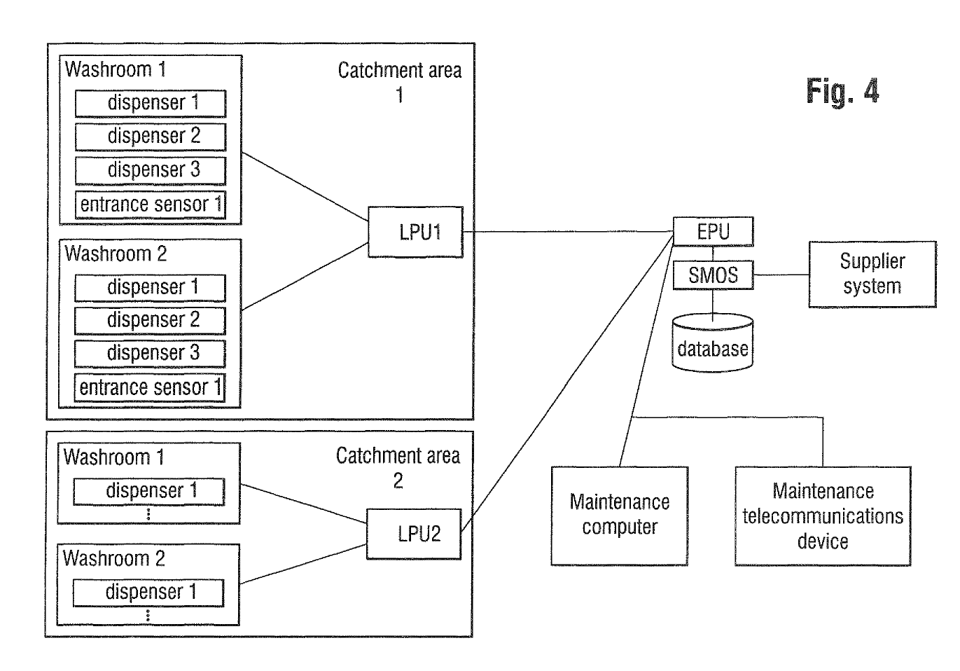

The local processing unit 49 is shown disposed on a wall of the washroom 40, but it may also be disposed on or above a ceiling of the washroom 40, or in a nearby room. The transmission means of the dispensers 47, 48 preferably wirelessly communicate the data to the local processing unit 49. The transmission means of the dispensers 47, 48 may be battery operated or hard wire powered. Either way, but particularly in the case of battery operation, the distance that the transmission means can communicate the data could be relatively limited, thereby requiring the local processing unit 49 to be positioned locally. The local processing unit can thus be described as being provided in a catchment area of data transmission for the product dispensers 47, 48. The local processing unit and the catchment area will be discussed in greater detail below in the context of the washroom system shown in FIG. 4.

One particular aspect of the local processing unit 49 is that it may be connected to an intranet or internet and may render a webpage accessible over the intranet or internet by a computer with the appropriate security rights so that the product levels in the dispensers 47, 48 can be monitored and maintenance operations be conducted based on this product level. The local processing unit 49 may communicate directly with a maintenance computer or a maintenance attendant's mobile device to send product level information, and particularly product low alerts so that a maintenance attendant is informed of a requirement for a product refill operation.

The dispensers 47, 48 may be equipped with further sensors, such as product jam sensors or housing tampering sensors, and these fault sensors may also be in communication with the local processing unit 49 to allow the local processing unit 49 to call upon a maintenance attendant to deal with any issues arising from the fault sensors.

FIG. 4 shows a washroom system comprising first and second local processing units (LPUs) LPU1, LPU2 that are each in communication with a system of dispensers and a system of entrance sensors distributed over first and second washrooms in respective catchment areas of the LPUs. The first catchment area for LPU1 may be defined by the dispensers that are within a wireless communication limit of the first local processing unit LPU1. Similarly, the second catchment area may be defined by the dispensers in respective washrooms that are able to communicate with the second local processing unit LPU2.

In FIG. 4, it is shown that a first washroom in a first catchment area includes three products dispensers, dispenser 1, dispenser 2, dispenser 3 and an entrance sensor and a second washroom includes first, second and third dispensers, dispenser 1, dispenser 2, dispenser 3 and also an entrance sensor. The second catchment area is likewise in communication with first and second washrooms having like dispensers and entrance sensors. In an alternative, the first or second local processing unit may be in communication with product dispensers in more than two washrooms or with dispensers and an entrance sensor in just one washroom.

The local processing units serve to accumulate data form product dispensers that they are in communication with. In the above, the communication is described as being wireless, but it could equally be by way of a wired connection. The dispensers include a transmission means that is able to send data from the relevant dispenser to the local processing unit. The data from each dispenser will at least include product level information and for at least one of the dispensers, this product information will be obtained by way of an ultrasonic level sensor, as described above. The product level sensor is preferably an ultrasonic level sensor for each of the paper dispensers in communication with the local processing unit. One or more of the paper or soap dispensers may use a more conventional product level sensor where this is convenient. A soap product dispenser may include a known type of soap level sensor, while a or each paper dispenser in communication with the local processing unit may include an ultrasonic product level sensor according to the present invention.

It is envisaged that the dispensers of FIG. 4 may be selected from at least one of a soap dispenser, a paper towel dispenser, a toilet tissue dispenser, wherein the paper towels may be provided in a stacked paper towel dispenser and/or a roll type paper towel dispenser. In the specific embodiment shown in FIG. 4, it is envisaged that the first, second and third dispensers for each washroom are respectively a soap dispenser, a toilet paper dispenser and a paper towel dispenser.

The entrance sensor in each washroom may be provided in a variety of ways, such as by way of a trigger sensor triggered by the opening of a door to the washroom, a motion sensor triggered by movement within the washroom and a light sensor triggered by the lights being turned on in the washroom.

The local processing units provide a relatively local communication network with the product dispensers within the respective catchment area. It is a job of the local processing unit to take the data received including washroom usage data from the entrance sensor and product level data from the one or more product dispensers and to communicate this information to an external processing unit EPU. The external processing unit is shown in communication with the first and second local processing units LPU1, LPU2 but may be in communication with a greater number. The communication between the local processing units and the external processing unit is generally over a greater range than that between the product dispensers and the entrance sensors and the local processing unit. This is enabled since the local processing units will generally be hardwired for power, while the product dispensers may be battery operated.

The external processing unit gathers the product level data and the usage data sent from the local processing units and enables a number of useful functions. The external processing unit could be used for providing statistical data on product levels as compared to usage of the washroom, which may be of interest to suppliers, manufacturers and distributors. In particular, the data received from the local processing unit preferably distinguishes between catchment areas, washrooms and/or particular dispensers. It is preferred that the data received from the local processing unit at least identifies the type of product dispenser (i.e. soap dispenser, paper towel dispenser, toilet tissue dispenser, etc).

In an alternative to that shown in FIG. 4, the dispensers of the various washrooms may be in communication directly with the external processing unit without being funneled through the local processing units via a telecommunications network.

The information received by the external processing unit may be stored in a database as shown in FIG. 4, thereby allowing historical statistics, analyses to be done on dispenser product levels and washroom usage.

In another function of the external processing unit, the external processing unit is in communication with a stock monitoring and ordering system SMOS so that stock levels in the dispensers and in warehouses supplying the dispensers can be monitored and new product delivered to the warehouses as required according to the stock monitoring and ordering system. The database allowing historical product level information to be analysed may be in communication with the stock monitoring and ordering system allowing predictive stock ordering to be implemented on the basis of past product requirements for a particular washroom, perhaps in view of usage information for that washroom.

The information sent from the dispensers via the local processing units may allow the external processing unit to determine when a new product cartridge or refill has been inserted in the dispenser, thereby enabling the stock monitoring and ordering system to debit the relevant stock level associated with the dispenser. The stock monitoring and ordering system can use this stock information to know when to order or have delivered a new shipment of products of one or more types of product (e.g. soap, paper towels, toilet tissue, etc). The stock monitoring and ordering system could be part of a supply system, or at least accessible by a supply system, so that the supply is able to automatically deliver the required product that is low in stock for a particular customer and also to have access to the historical washroom usage and product level information for one or more customers, which will be valuable for customer service and customer care purposes.

Another useful function of the external processing unit is that it is in communication with a maintenance computer and/or a mobile telecommunications device (such as a personal digital assistant (PDA), cell phone or the like). The maintenance computer may also be a less mobile machine such as a desktop or a laptop installed in a maintenance personnel office. The external processing unit is configured to send out maintenance alerts to the maintenance computer indicating that a particular washroom needs a maintenance operation based on the product level of the one or more dispensers in that washroom, and perhaps may also identify the particular dispenser that requires the maintenance operation (i.e. product refill). The dispensers may also be configured to communicate full conditions, such as dispenser tampering or product jam, which can be communicated to the external processing unit via the local processing unit and then further to the maintenance computer or the maintenance telecommunications device so that a maintenance attendant can deal with the problem.

A particular advantageous feature of the ultrasonic level sensor of the present invention is that it enables data to be communicated to the external processing unit, perhaps via the local processing unit, indicating a quantitative level of the product in the dispenser, rather than simply a binary product low or product level sufficient alert. The quantitative analysis is enabled since the distance that the ultrasonic beam travels is correspondable directly to a quantitative product level. This quantitative product level is useful for statistical purposes in the historical database as well as for accurate stock monitoring and ordering in the stock monitoring and ordering system and even allows maintenance operations to be more precisely timed. For example, the external processing unit could communicate to the maintenance computer or the maintenance telecommunications device that dispenser 1 in washroom 1 is 50% full, dispenser 2 is 25% full, and dispenser 3 is 40% full. The maintenance computer of the external processing unit may be able to compare these values to corresponding values for a second washroom and determine, perhaps based on an average fullness level of the dispensers, which of the first and second washrooms has the higher maintenance operation priority.

The local processing units or the external processing unit may be accessible via an internet page or intranet page so that the product levels in each of the dispensers can be inspected. If this is the case, the maintenance computer would be able to access this webpage, making the sending of product low alerts from the external processing unit less necessary. Further, the maintenance computer could automatically monitor the product levels communicated in the webpage and thus send maintenance jobs to a maintenance attendant based on that information to the maintenance attendant's mobile communications device. The supply system may also be allowed access to this webpage, thereby allowing the supply system to monitor product information for stock delivery purposes.

In the above, the stock monitoring and ordering system is described as being part of the supply system or at least in communication with the supply system. It could, however, be part of a client system in which case the stock is ordered automatically by a message to the supplier system, rather than the stock being automatically delivered using the stock monitoring and ordering system of the supply system.

Various alternatives to the above-disclosed embodiments that fall within the scope of the claimed invention could be provided.

For example, in FIGS. 1 and 2 of the present invention, the ultrasonic beam reflects directly off of a web surface of the sheet product. This is the preferred configuration since it allows the ultrasonic level sensor to be implemented into various such dispensers with minimum modifications. It can be imagined, however, that a surface could be provided that is biased against the top of the stack 3 of FIG. 1 so that it moves away from the ultrasonic level sensor 12 as the stack 3 depletes or a movement arm could be biased against the outside circumferential surface of the roll product 22 so that it moves radially inwardly as the roll 22 depletes and the beam may reflect off of this surface. This could be useful if the surface is provided as a particularly reflective surface for reflecting ultrasonic energy, for example as compared to paper web.

In the embodiments of FIG. 1, the first echo of the ultrasonic energy is detected. That is, the beam travels to and from the stack or the roll product and the distance determinations are made based on this first echo. An alternative to this would be to detect higher order reflections of the ultrasonic beam so that the beam has to travel a number of to and from iterations to and from the stack and the processor determines data concerning the distance travelled form this higher order reflection. Such an embodiment is not preferred as the strength of the reflected ultrasonic signal will diminish for each traversal to and from the dispensable product. A multiple travel path embodiment may, however, be useful since the overall travel path will be multiple times the length of the distance to and from the dispensable product, where this extra time of flight may allow a reduced error product level calculation.

In the given embodiment, a time of flight method is used in that a time between a drive signal and a reflection detection signal is taken and correlated to a product level contained in the dispenser. Other algorithms are known, such as a phase shift algorithm, whereby the difference between the phase of the emitted beam and the phase of the reflected beam is correlatable to a distance travelled by the beam, thereby corresponding to a product level contained in the dispenser.

1.-45. (canceled)

46. A dispenser for dispensing paper or non-woven sheet product for wiping, wherein the level of sheet product contained in the dispenser decreases as the sheet product is dispensed, the dispenser comprising an ultrasonic level sensor for determining the level of the sheet product contained in the dispenser, wherein the ultrasonic sensor is arranged to direct the ultrasonic beam toward a surface associated with the sheet product, wherein a distance that the beam travels to the surface changes progressively as the level of the sheet product in the dispenser changes from a full condition to an empty condition.

47. The dispenser of claim 46, wherein the ultrasonic level sensor is configured to emit an ultrasonic beam at a surface of the sheet product, or a surface indicative of the level of the sheet product, and sense an echo received from the surface to allow a determination to be made on the level of the sheet product contained in the dispenser.

48. The dispenser of claim 46, wherein the level sensor outputs at least one signal indicative of a distance traversed by the echoed ultrasonic beam, which signal is indicative of a distance from the ultrasonic level sensor to the sheet product, thereby allowing the level of the sheet product in the dispenser to be determined.

49. The dispenser of claim 48, the signal comprising a beam transmission signal and an echo receipt signal for determining a distance indication to the sheet product, which is representative of the sheet product level in the dispenser.

50. The dispenser of claim 46, wherein the ultrasonic level sensor outputs a first signal concerning the ultrasonic beam that is emitted and a second signal concerning the echo of the ultrasonic beam, which signals are comparable to determine a distance to the sheet product, wherein the distance changes as the level of the sheet product changes.

51. The dispenser of claim 46, wherein the ultrasonic level sensor is arranged to emit the ultrasonic beam so that a central axis of the beam extends substantially perpendicularly with respect to a reflection surface of the sheet product that produces the echo.

52. The dispenser of claim 46, wherein the dispenser includes a product housing defining a cuboid shaped interior area shaped to receive a cuboid shaped stack of sheet products.

53. The dispenser of claim 52, wherein the ultrasonic level sensor is positioned to direct an ultrasonic beam toward a surface associated with the stack that moves away from the sensor as the sheet products in the stack are dispensed and the stack consequently depletes and to receive an echo from the surface.

54. The dispenser of claim 52, wherein the ultrasonic level sensor is located in a top or bottom of the housing, wherein the sensor directs the ultrasonic beam in the stacking or dispensing direction, which is a top to bottom direction, and receives an echo directed in the stacking or dispensing direction, and wherein the ultrasonic level sensor is positioned to direct the beam at a top or bottom surface of the stack in the stacking direction wherein a distance to the surface from the ultrasonic level sensor changes progressively as the sheet product is dispensed.

55. The dispenser of claim 46, wherein the dispenser comprises a product housing defining an interior area shaped for receiving a roll of sheet product, wherein the dispenser includes an axle about which a core portion of the roll of sheet product rotates.

56. The dispenser of claim 55, wherein the ultrasonic level sensor is arranged to direct an ultrasonic beam at a circumferential surface of the roll, and wherein the ultrasonic level sensor is arranged to direct the beam substantially radially and to receive a substantially radially directed echo.

57. The dispenser of claim 46, comprising a wired or wireless transmission device for reporting the product level or an indicator light for reporting a product low condition determined based on the product level.

58. A system for determining a level of paper or non-woven sheet product contained in the dispenser, wherein the level of sheet product in the dispenser decreases as the sheet products are dispensed from the dispenser, the system comprising
the dispenser;
an ultrasonic level sensor; and
a processor configured to:
determine a level of the sheet product based on an ultrasonic echo sensed by the ultrasonic level sensor, wherein the sensor is arranged to direct the ultrasonic beam toward a surface associated with the sheet product, wherein a distance that the beam travels to the surface changes progressively as the level of the sheet product in the dispenser changes from a full condition to an empty condition;
wherein the processor is configured to determine a quantitative result indicating the level of sheet product in the dispenser that varies progressively from a product full condition to a product empty condition, such as in at least three, four, five, six, seven, eight, nine or ten levels or continuously.

59. The system of claim 58, wherein the ultrasonic level sensor is configured to emit an ultrasonic beam and sense an echo of the ultrasonic beam.

60. The system of claim 58, wherein the ultrasonic level sensor is arranged to emit an ultrasonic beam to a surface whose level changes in indication of the level of sheet product, and configured to sense an echo from the surface, to thereby garner an indication of the product level contained in the dispenser.

61. The system of claim 58, wherein the processor is configured to determine data indicative of a distance traversed by the echoed ultrasonic beam, which data is indicative of a distance from the sheet product, thereby indicating the level of the sheet product contained in the dispenser.

62. The system of claim 58, wherein the processor is configured to receive a beam transmission signal and an echo receipt signal from the ultrasonic level sensor and to determine a distance indication to the sheet product from the signals, which is representative of the level of sheet product in the dispenser.

63. The system of claim 58, wherein the processor is configured to compare signals from the ultrasonic level sensor concerning the ultrasonic beam emitted and the ultrasonic beam echo sensed to determine an indicator of a distance to the sheet product, wherein the distance changes as the sheet product level changes to determine the level of the sheet product in the dispenser.

64. The system of claim 58, wherein the ultrasonic level sensor is arranged to emit the ultrasonic beam so that a central axis of the beam extends substantially perpendicularly with respect to a reflection surface of the sheet product that produces the echo.

65. The system of claim 58, wherein the system is configured to determine when the product is low based on the determination of the sheet product level and to issue an alert for a maintenance attendant or to switch an indicator light when the product is determined to be low so that a sheet product replenishment requirement is made known.

66. The system of claim 58, comprising at least one further dispenser having a product level sensor.

67. The system of claim 66, wherein the at least one further dispenser includes a soap dispenser, a roll sheet product dispenser, and/or a stack sheet product dispenser.

68. The system of claim 66, wherein the at least one further dispenser and the dispenser are configured to report in a wired or wireless manner a determined product level to a local processing unit or to an external processing unit.

69. The system of claim 68, wherein the local or external processing unit constructs a webpage available over the internet or an intranet that allows a maintenance attendant or other interested party to view the level conditions in each dispenser.

70. The system of claim 68, wherein the local processing unit or the external processing unit is configured to determine a product low condition and report an alert to a maintenance attendant

71. The system of claim 66, wherein the or each dispenser reports in a wired or wireless manner product level information with a unique identifier for the dispenser so that the level information is distinguishable between dispensers.

72. The system of claim 66, wherein the system includes a stock monitoring and ordering system configured to monitor product level sensors of a plurality of dispensers, including said dispenser, and to order or deliver new stock when the stock is determined to be low based on the sensed product levels.

73. The system of claim 72, wherein the stock monitoring and ordering system includes a database for storing product level information for each of the dispensers.

74. The system of claim 73, wherein an entrance sensor for determining a guest entering or using the washroom is provided that allows washroom usage information to be gathered.

75. The system of claim 74, wherein the entrance sensor includes a transmitter so that usage information from the entrance sensor is communicable to the system for monitoring and ordering stock so that the information can be stored in the database.

76. The system of claim 58, wherein the processor is configured to determine a product low status from the sheet product level and transmit the product low status to a processing unit (external to the dispenser) in a wired or wireless manner or to switch an indicator light to indicate the product low condition.

77. A method of determining a level of paper or non-woven sheet product for wiping in a dispenser, wherein the level of sheet product in the dispenser decreases as the sheet product is dispensed from the dispenser, comprising:
determining from an ultrasonic echo a level of the sheet product contained in the dispenser, wherein the ultrasonic beam travels toward and reflects off a surface associated with the sheet product to produce the echo, wherein a distance travelled by the ultrasonic beam to the surface progressively changes as the sheet product level changes.

78. The method of claim 77, wherein the method comprises emitting an ultrasonic beam and sensing the echo, and determining from the sensed echo the level of the sheet product contained in the dispenser.

79. The method of claim 77, wherein the method comprises emitting an ultrasonic beam at a surface whose level changes in indication of the level of sheet product contained in the dispenser, and
sensing an echo of the ultrasonic beam reflected from the surface, to thereby garner an indication of the product level contained in the dispenser.

80. The method of claim 77, wherein a characteristic of the ultrasonic beam emitted is compared to a corresponding characteristic of the echo to determine an indication of the distance to the sheet product, which distance changes progressively as the level of sheet product changes, and which distance indication is representative of the level of sheet product contained in the dispenser.

81. The method of claim 77, wherein the ultrasonic beam is emitted so that a central axis of the beam extends perpendicularly with respect to the reflection surface.

82. The method of claim 77, wherein the method includes the step of determining a quantitative result indicating the level of sheet product in the dispenser that progressively varies from a product full condition to a product empty condition.

83. The method of claim 77, wherein the method comprises determining a product low condition from the determination of the product level in the dispenser and switching an indication light or alerting a maintenance attendant when a product low condition is determined.

84. The method of claim 83, wherein the alert is sent to a mobile telecommunications device of a maintenance attendant.

85. The method of claim 77, comprising delivering refill sheet product to a customer's stores at a time determined based on the level of sheet product contained in the dispenser and the level of sheet product contained is at least one further dispenser used by the customer.

86. The method of claim 77, comprising reporting the product level or a product low condition based on the product level and consequently refilling the sheet product in the dispenser through a maintenance attendant receiving the report.
